(19) United States
(12) Patent Application Publication
(10) Pub. No.: US 2009/0187420 A1
(43) Pub. Date: Jul. 23, 2009

(54) Methods and Systems for Providing Individualized Wellness Profiles

(76) Inventors: William S. HANCOCK, Brookline, MA (US); Tomas REJTAR, Somerville, MA (US); Lakshmi Manohar AKELLA, Medford, MA (US); Christina ORAZINE, Lincoln, RI (US); Haven H. BAKER, Belmont, MA (US)

Correspondence Address: WILMERHALE/BOSTON, 60 STATE STREET, BOSTON, MA, 02109, US

(21) Appl. No.: 12/272,218

(22) Filed: Nov. 17, 2008

Related U.S. Application Data
(60) Provisional application No. 60/988,346, filed on Nov. 15, 2007.

(51) Int. Cl. G06Q 50/00

(52) U.S. Cl. 705/2; 707/104.1

(57) ABSTRACT

Methods and systems for providing a user with personalized wellness and health information are described. More particularly, methods and systems are provided for creating an individual health profile display, presented on a network-based interface, based on the analysis of a user-submitted biological sample that has been compared to a knowledge database, and including information related to the comparison.

### CROSS-REFERENCE TO RELATED APPLICATION

This application claims the benefit under 35 U.S.C. § 119(e) of U.S. Provisional Patent Application No. 60/988,346, filed Nov. 15, 2007, which is hereby incorporated by reference herein in its entirety.

### TECHNICAL FIELD

The present invention relates to a method and system for providing a user with personalized health information, and in particular for example, information presented in an online, interactive environment.

### BACKGROUND

Medical research is continuously producing scientific information of interest and use to many. However, navigating the rich, complex volume of the world's scientific information presents a significant challenge to an individual user, who wishes to identify and access with ease that information relevant to him/herself.

The internet has become a major resource for providing high value healthcare information for the general public. According to the Pew Internet & American Life Project (http://www.pewinternet.org), 113 million U.S. residents searched for healthcare information online in 2006, and eight million individuals searched online daily for information about diets, diseases, and physicians.

Some efforts have been made to personalize the online presentation of healthcare information for a user. For example, in addition to static, informational websites, interactive, diagnostic websites exist, which provide evaluations and assessments based on information provided by the user. Such sites typically collect health information from the user by questionnaire. Services also exist to process user-submitted samples, which provide data for evaluation and medical research.

Nonetheless, a need exists for a method and system that can empower the healthcare user significantly by organizing medical and wellness literature for an individual based on their own biological signature or phenotype.

### SUMMARY

A method and system are described for providing a user with personalized health information derived from a user-submitted biological sample that has been compared to a knowledge database. In a particular embodiment, for example, information is presented in an online, interactive environment. This method and system combine a network such as the internet, databases, and advances in various fields of medicine, and in particular the field of protein biomarkers, to provide an interactive wellness profile. This method and system allow a user (individual or specific user/patient group) to explore data from (i) individual user-submitted samples (e.g., mass spectrometry data related to disease/wellness protein changes) and (ii) user-provided personal information (e.g., dietary preferences, community of like-minded individuals or disease sufferers, pharmaceutical usage) in the context, for example, of an interactive and informative knowledge database. The method comprises individual sample analysis, interrogation of the results against a knowledgebase, interactive exploration of an individual profile, and the presentation of products and actions related to lifestyle and health profiles. The system, thus, is an information tool that may, for example, combine wellness and medical information and an individual's personal medical information, family history, and goals to provide insight into individual health or wellness conditions, suggest user actions (e.g., to complement treatments and information available through the healthcare system), and highlight health or disease changes. The system will strengthen synergistically with increased numbers of users and will improve curation of the wellness and medical literature.

In one aspect, the disclosure provides a method for generating a wellness profile for a user, comprising the steps of receiving from a user for analysis at least one sample; performing the analysis upon the sample and generating results based on the analysis; comparing the results of the analysis to a database containing results from analyses of a plurality of samples received from individuals; creating an individualized health profile display based at least on the results of the comparisons; providing a network-based interface for the user to explore the created individual health profile display; and providing information related to at least the results of the comparisons to the display.

In one or more embodiments, the sample is a biological liquid specimen, such as plasma, serum, or urine. In one or more embodiments, the information is genomics or metabolomics data. In one or more embodiments, the analysis is mass spectrometry, spectroscopy (such as nuclear magnetic resonance or infrared spectroscopy), expression profiling, or analysis of genomic DNA.

In one or more embodiments, the method further comprises the step of receiving personal information about the user.

In one or more embodiments, the method further comprises the step of analyzing cell cultures from diseased cells with or without one or more bioactive treatments based on the results of the comparisons.

In one or more embodiments, the step of comparing the results of the analysis to a database further comprises creating one or more ordered lists. In one or more embodiments, the step of comparing the results of the analysis to a database further comprises creating a graphical representation of similarity. In one or more embodiments, the graphical representation is a color or grayscale intensity map.

In one or more embodiments, the step of providing information related to the correlation of user data to the display comprises: moving, by the user, a pointing device over the display to select a portion of the display; and providing at least one of a link and information associated with the selected portion of the display.

In one or more embodiments, the portion of the display selected by the user is associated with a condition and the at least one of a link and information associated with the selected portion of the display is associated with the condition.

In another aspect, the disclosure provides a method for generating a wellness profile for a user, comprising the steps of: comparing user data to a database containing results from analyses of a plurality of samples received from individuals; creating an individualized health profile display based at least on the results of the comparisons; providing an network-based interface for the user to explore the created individual health profile display; and providing information related to at least the results of the comparisons to the display.

In one or more embodiments, the user data results from proteomic analysis of a biological liquid specimen. In one or more embodiments, the user data includes personal information about the user.

In one or more embodiments, the step of comparing a user data to a database further comprises creating a graphical representation of similarity. In one or more embodiments, the method uses a color or grayscale intensity map for indicating a level of correlation between the user data and data locations on the display.

In one or more embodiments, the step of providing information related to the correlation of user data to the display comprises: moving, by the user, a pointing device over the display to select a portion of the display; and providing at least one of a link and information associated with the selected portion of the display.

In one or more embodiments, the network-based interface is provided on a mass communication device.

### BRIEF DESCRIPTION OF THE DRAWINGS

FIG. 1 is a schematic flow chart illustrating one embodiment of the method.

FIG. 2 shows increase in tumor volume over time in a breast cancer model.

FIG. 3 shows MZ (mass/charge) patterns at (a) 781 units and (b) 945 units for samples associated with a growing breast cancer tumor.

FIG. 4 is a schematic feature map illustrating pairwise comparisons of different MZ bio-bars for eight samples from the breast cancer study.

FIG. 5 shows MZ patterns at (a) 750 units and (b) 781 units for samples associated with a human diabetes study.

FIG. 6 is a schematic flow chart for generating an individualized health profile display, according to one embodiment of the method.

FIG. 7 shows a color or “heat” map, two possible cursor positions, and linked information displayed, according to one embodiment of the method.

FIG. 8 shows an ordered list, two possible cursor positions, and linked information displayed, according to one embodiment of the method.

### DETAILED DESCRIPTION

Significant advances in the comprehensive, systematic characterization of the human proteome have facilitated the development of biomarkers for the prevention, diagnosis, and therapy of a variety of diseases. Herein, a system and method for utilizing biomarkers for a personalized, network-based exploratory educational resource for a user are described.

The method and system provide empowerment for an individual's interest in wellness. It may operate in conjunction with the healthcare system or outside the healthcare system, in the area of info-education or entertainment. It exploits a network such as the internet, with its ability to maintain and update large databases, and may be used in connection with a financial model based on sale of advertising and products related to the results of the analysis of parameters associated with the individual when compared to a previously created knowledgebase. Sources of revenue could include, but are not limited to, charges for user-submitted sample analyses, charges for internet partnerships (traffic directed to the partner websites could, for example, be measured by monitoring click-through), regular wellness or health updates to a community of interested users, and sales of related health products and information.

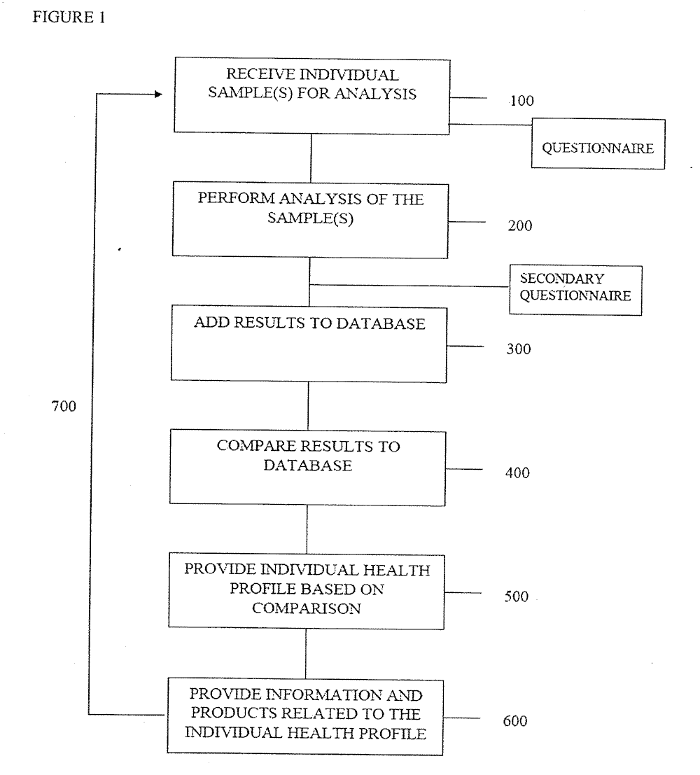

With reference to FIG. 1, in one embodiment, a user submits a sample 100 for analysis, for example, proteomic analysis. The sample may be blood plasma, considered one of the most useful specimens for biomarkers, and may involve technologies to isolate sub-fractions of the blood proteome that are related to disease processes. The sample may also be another biological specimen such as another fluid (e.g., serum, urine, cerebrospinal fluid) or a tissue biopsy.

In connection with the sample submission, the user also fills and submits a questionnaire providing user known information, such as personal data relating to age, gender, geographic location, health history, current medical ailment or treatment, drug(s) being taken, etc.

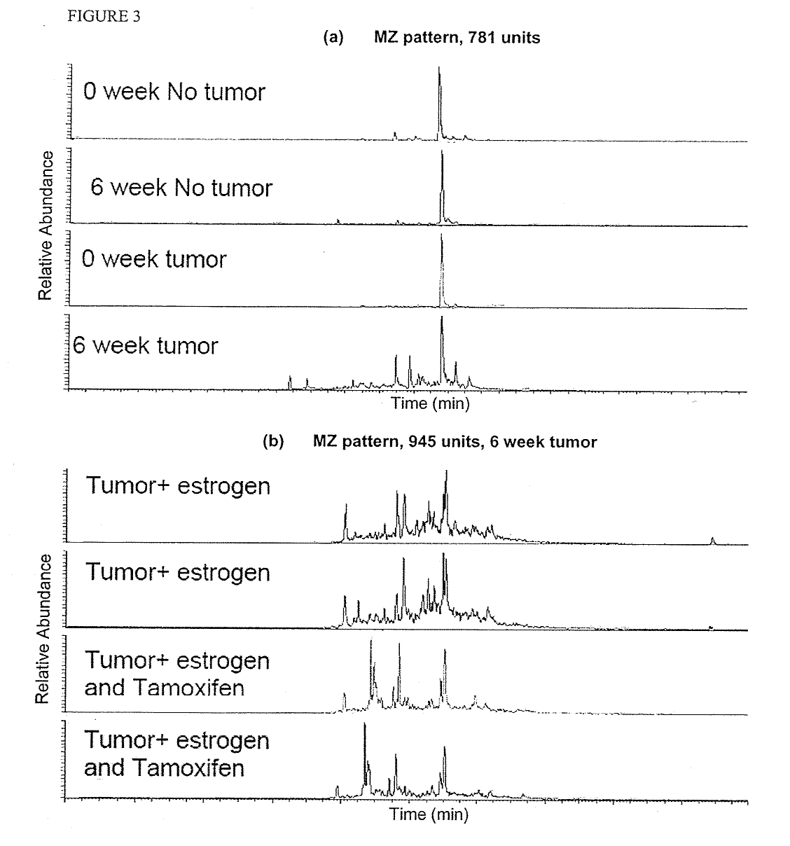

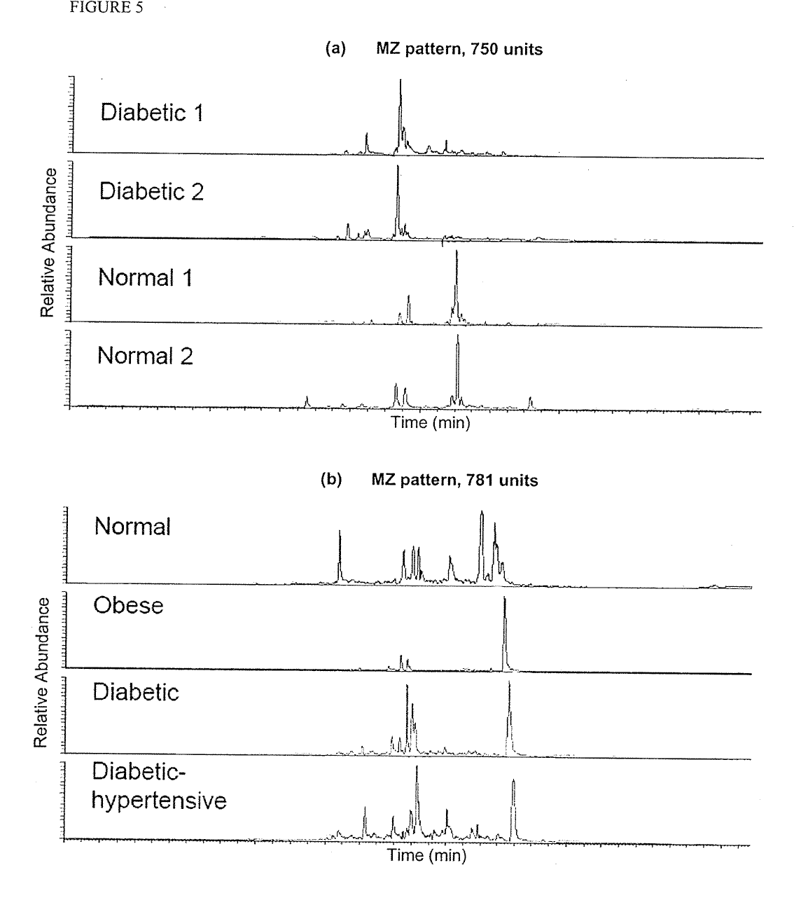

The sample is analyzed 200 using any validated systems biology method. The analysis method provides an user-specific, information-dense signature of macromolecules, including but not limited to proteins, peptides, polysaccharides, lipids, DNA, RNA, and small molecules. The analysis method may be liquid chromatography-mass spectrometry (LC-MS) or matrix-assisted laser desorption/ionization-mass spectrometry (MALDI-MS), which may be coupled to a technology to isolate a fraction of the proteome (e.g., multi-lectin affinity chromatography for analysis of the glycoproteome or molecular weight fractionation to isolate the peptidome). These methods can currently measure on the order of 5000 MZ (m/z or mass/charge) patterns per sample and can follow phenotypic changes. The MZ patterns represent sensitive chemical signatures that are detected by mass spectrometry and that change with disease and environmental factors. This currently available technology can, for example, detect growing cancer in a mouse model, as well profile human diseases such as cancer and diabetes. Examples of MZ patterns at selected m/z values (units) are illustrated in FIG. 3 and FIG. 5, with relative abundance plotted as a function of time. The data shown in these figures was obtained from a series of ion chromatograms covering all signals above a signal to noise threshold at a range of pre-selected masses. Other types of mass spectrometry output can be selected to gain information such as the fragmentation pattern of selected ions (MS/MS patterns). The analysis method may also be nuclear magnetic resonance (NMR) or other forms of spectroscopy such as infrared spectroscopy. The method may also be genomic analysis (e.g., expression profiling) and/or metabolomic analysis.

In a preferred embodiment, a database is developed from the data collected from each of a plurality of individual blood samples. The database is scalable and can be presented to visualize significant differences or comparisons or correlations between samples. The complexity of the volume of data associated with each individual analysis is reduced in ways that preserve essential features while facilitating easy comparison and storage of large population studies.

The data collected from each sample, together with additional information or annotation from the questionnaire, or similar sources, or separate studies, enable a knowledgebase to be created. The knowledgebase may include, but is not limited to, results from analyses of a plurality of user-submitted samples and user-submitted personal information (e.g., the user's immediate and long-term wellness goals, family wellness profile, and current wellness profile). While a greater number of samples provides better correlation results, it is estimated that around 10,000 samples will provide sufficient data to achieve statistical significance and generate acceptable results (however, as there are at least 4000 diseases, only an extensive knowledgebase may make associations with acceptable statistical specificity for most of the diseases). It is also expected that a smaller knowledgebase of as few as 20 samples may provide useful information to define a community of interest (e.g., a group of rare disease sufferers) and to facilitate the sharing of wellness and/or disease information. Individual sample results are preferably continuously added to 300 and correlated with 400 the knowledge database. Sample results may be tagged with the user-submitted personal information, and may, thus, be compared, correlated, and clustered based on criteria such as age, gender, medical history, or disease status. Sub-spaces of the knowledgebase corresponding to groups of samples with similar information can be processed separately to limit influence of factors that are unlikely to be related. It is a feature of this method and system that novel associations (e.g., disease associations, dietary effects, ethnic associations) may be developed for the analyzed data based on user profiles, while the knowledgebase as a whole is not subdivided according to any particular patient population. Associations of the knowledgebase with sample information can yield important information such as separation of influence of various environmental, genetic, or habit factors. For example, features attributable to a certain type of cancer, diet, inflammation, or a combination thereof, can be distinguished.

A secondary questionnaire may be distributed to the user at some time following sample analysis with targeted questions based on the features found in the user-submitted biological sample. The information from this follow up questionnaire can be used to update the knowledgebase.

Quantitative data, changes, and correlations and comparisons may be reported 500 in a variety of ways, including but not limited to ranked lists and graphical presentations. In one embodiment, informatics tools are used to generate color or “heat” maps to visualize the profile of an individual's blood analysis and indicate the amount of associations with different diseases and environmental factors, for persons generally, or persons having similar backgrounds (age, gender, family history, medical history, etc.). A similarity ranking with other individuals having a similar disease profile may also be presented.

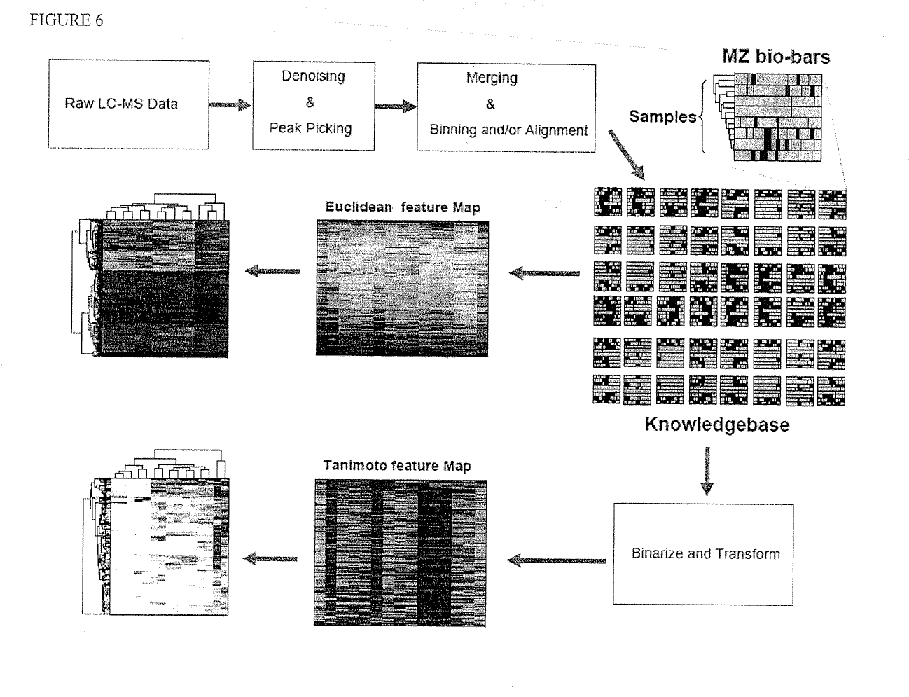

FIG. 6 is a schematic flow chart for generating an individual health profile display, according to one embodiment. As shown in FIG. 6, “Raw LC-MS Data”, that is, MZ patterns such as those in FIGS. 3 and 5, may be processed by methods known in the art (“Denoising & Peak Picking” and “Merging & Binning and/or Alignment”) and represented by MS or MZ “bio-bars” (see FIG. 6, upper right corner, two squares marked “m/z values”; each horizontal row, of which there are fifteen, represents a bio-bar from a different sample), wherein the intensity of the bar is proportional to the relative abundance. The bio-bars are made part of a created database (see FIG. 6, schematic 6×8 grid of squares marked “Knowledgebase”, each square containing eight different bio-bars/“Samples”/rows) and may be compared for different samples (see, for example, FIG. 6, “Euclidean feature Map” and “Tanimoto feature Map” and two-way cluster maps thereof, illustrating comparisons, here Euclidean and Tanimoto similarities, between bio-bars from different “Samples” in the “Knowledgebase”). Further, neural networks and other artificial intelligence methods, and Bayesian networks and other belief networks, may be used to develop a hierarchy of causes and associations from the information present in the knowledgebase.

In one or more embodiments, a Tanimoto inter-point distance matrix for all samples forms the foundation of the knowledgebase. The entire matrix can be interrogated, or specific sub-spaces can be extracted. The distances in the matrix are arranged in the order (2,1), (3,1) . . . (n,1), (3,2) . . . (n,2) . . . (n,n−1) for a set of n samples. Thus, a specific set of pairs of samples of interest can be selected, and the corresponding sub-space can be clustered. When processing hundreds or thousands of LC-MS samples, supervised, semi-supervised, or unsupervised machine learning approaches to extract relevant information for wellness profiles can be used, depending on the number of and/or the amount of information about the samples. For example, unsupervised training/learning with the help of a Self-Organizing Map (SOM) can be applied to automatically identify regions of interest. In this case, the matrix is transposed and SOM generated in this new space. Individual sample pairs are placed in centroids, represented, for example, by hexagons. The SOM map, with a coloring scheme such as a standard U-Matrix coloring, can be used to extract interesting sub-spaces automatically. The sample pairs in the interesting sub-spaces can be clustered for specific pattern analysis. For example, for each set of sample pairs and the similarity matrix generated for various m/z values using Euclidean or Tanimoto distances, a single all-pairs similarity vector can be generated by mean/median or some other aggregating function and a symmetric inter-point distance matrix can be reconstructed. Then, by applying dimensionality reduction methods like Principal Component Analysis or Multi-Dimensional Scaling and plotting the samples in two or three dimensions, similarities between individual samples can be analyzed.

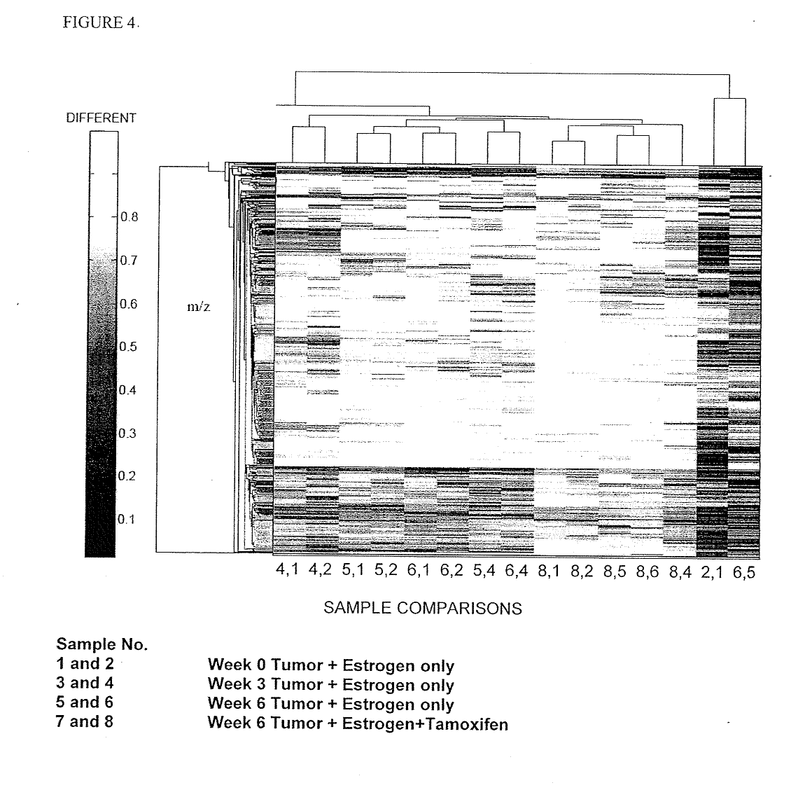

Referring to FIG. 4, there is shown a typical thermal or heat map comparing the analysis of a user to the results stored in the knowledge database. LC-MS data for individual subjects is normalized and intensity is converted to binary code suitable to determine sample inter-point distance, for example in Tanimoto space, D_{T}(S₁,S₂), given by the equation:

D_{T}(S₁,S₂)=1−|S₁∩S₂|/|S₁∪S₂|.

Individual inter-sample distances are further processed and can be visualized using the heat map, in which the x-axis shows individual sample pairs, the y-axis shows m/z values, and color/intensity represents similarity. For those instances where the correlation is large, an active color such as red or a deep black (if monotone) can be employed. For those areas where there is very little correlation, a light color such as yellow or a light white can be used (for example, samples in light color that do not cluster with any other sample can be identified as outliers, likely resulting from problematic raw data analysis). In addition, the heat map is a substantially continuous color variation indicating those areas which are very likely, more likely, more unlikely, or very unlikely, for example, to be correlated. The use of this map will be described later as the user is enabled to interact with it and attain yet further information.

It is a feature of this method and system that insights are gained into the overall health of an individual, since blood, for example, reports on all tissues and organs. Reporting is not restricted to focus on one disease, as is the case for much medical treatment and research, but may represent a “holistic” approach, monitoring and addressing the overall health of an individual.

Based on the personalized analysis and information presented to an individual, the user may decide what type(s) of additional information or products to access using additional information and interest links provided 600 on the display. The options provided may include but are not limited to descriptions of traditional medical testing, links providing more information regarding noted correlations, potential wellness actions, and alternative lifestyle programs (e.g., herbal treatments). The information may be specific to a disease or a more general protein change (e.g., due to stress) or other system responses.

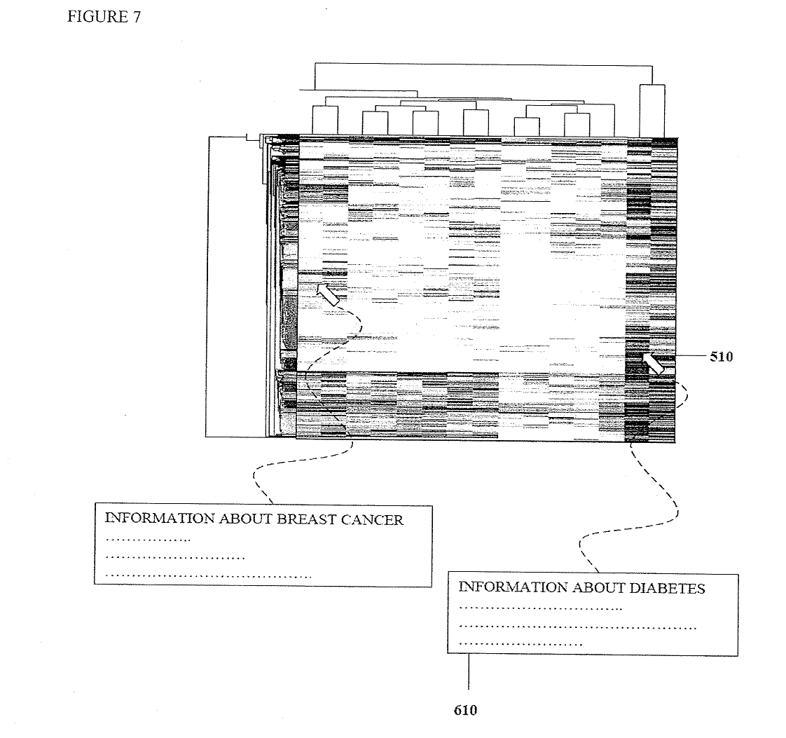

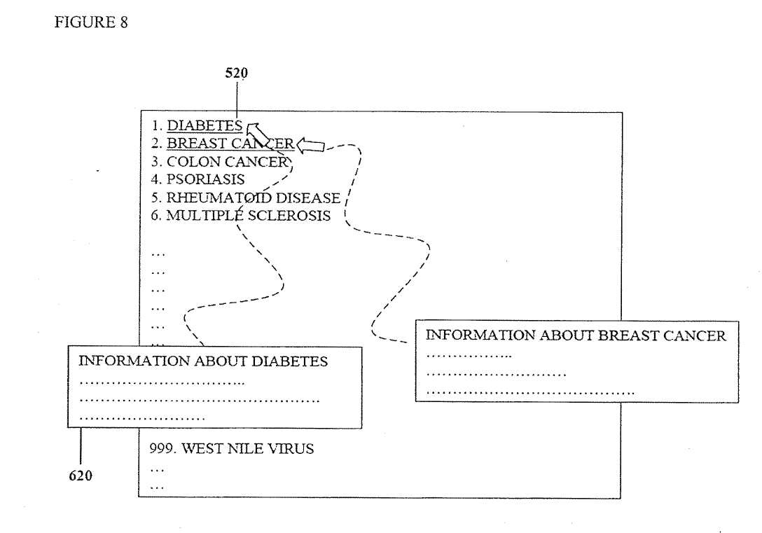

Referring to FIG. 7, and to FIG. 8, in typical displays, in addition to the heat map (FIG. 7) or linked list (FIG. 8), the system provides related information. The related information can be displayed beside the heat map or link list (or any other information display mechanism) and, as the user moves a pointing device (cursor) over a particular portion of the heat map 510, or over a particular entry in the linked list 520, both of which may be related to a condition, the system will provide in area 610 or 620 links and further information relating to the condition being highlighted. Thus, referring to FIG. 7 when the user passes the cursor over an area such as area 510 which is indicated as high correlation, the system will provide further information relating to that condition 610, for example, diabetes, which enables the user to either obtain more information on the internet, or to link to other sources where additional information might be provided. A similar methodology is provided in connection with the linked list of FIG. 8. The profile and links can be updated automatically based on iterative searching of the medical and wellness literature.

Retrieval of information and graphical objects showing association clusters can be achieved by redirection of controlled vocabulary searches driven from matching individual profiles with the knowledgebase. For example, controlled vocabulary abstract hyperlinks, which are directed to a redirection facility, can be provided (e.g., using an offline web browser). The redirection facility can control the medical and wellness literature searched and limit to a preselected dataset. For example, the redirection facility can have preloaded information and graphical links preselected for specific wellness profiles. The redirection facility can also direct the user to preselected advertising opportunities, which can be responsive to different factors such as the user's subcategories in the knowledge base and/or the user's wellness goals.

The system-provided information may be output to a electronic communication device including, but not limited to, a computer, a personal digital assistant, a cell phone, a smartphone, and a telephone. Filters may be employed to remove “noise” (e.g., gender-specific diseases). As a business model, click-through provided by the site may incur from the site being visited or costs payable to the referring site, as is well known in the field. A continuous learning model for organization of medical information may be used to track the links used by users following the knowledge database, to provide additional associations (e.g., a certain health food used successfully by a group of people).

A user could represent or be a part of a user group-a specific interest group such as a patient group or a medical foundation, or a group of individuals with similar wellness goals. A user group may organize the collection of specific samples; for example, a group dedicated to fighting ovarian cancer in family members may submit samples from women at risk for ovarian cancer. Much of the database, thus, may be built up by individual interest groups, who may derive important research information. In addition, specific support groups may make extensive use of this database—for example, for educating disease sufferers and for guiding efforts to mitigate the impact of disease through lifestyle changes. An individual user may authorize use of user-submitted samples for a user group or designated individuals, such as friends or family members. A user group may require fewer participants to yield satisfactory information (e.g., 100-1000 participants, as compared to 10,000 for the entire system). The system may also be used to identify potential user groups (e.g., people with common health conditions) and to encourage exchange of information between user groups.

For an individual user, sample analysis can be repeated 700 using later samples. Regular reanalysis is considered highly beneficial, and may be viewed as a part of disease prevention. In addition, individuals could use this information as a “wellness index,” and/or to monitor changes they have initiated in their life activities to improve their wellness profile. Later samples may be submitted, for example, on an annual basis or after significant events, or on some other regular schedule to monitor the use, for example, of nutriceuticals, dietary aids, or wellness programs. Timing for repeated analysis can be prompted. After development of the knowledge database (estimated at greater than at least 10,000 samples) individuals would typically pay a fee to submit their sample, for example, the results of their blood analysis, a panel of biomarkers, to the knowledge database, and obtain from a matching or correlation process the relative predictions of the association with, for example, diseases and unhealthy lifestyle choices.

Examples of bio-bar studies, for breast cancer and diabetes, are described below. The examples mentioned are for illustrative purposes only, to demonstrate bio-bar value as a component of the method and system, and are not meant to limit the scope or content of the invention in any way.

### EXAMPLES

### Example 1

### Visualization of Differences in Bio-Bars that Reflect a Disease State

This example shows how comparisons and correlations of results from mass spectrometry analysis can indicate progression of tumor growth and response to different treatments, and how the comparisons and correlations can be reported graphically.

A mouse model for breast cancer was used, involving athymic nude mouse xenografts as preclinical drug screens and a genetic mutant with an inhibited immune system (decreased T cell count). No rejection response was observed in connection with many different types of tissue and tumor grafts.

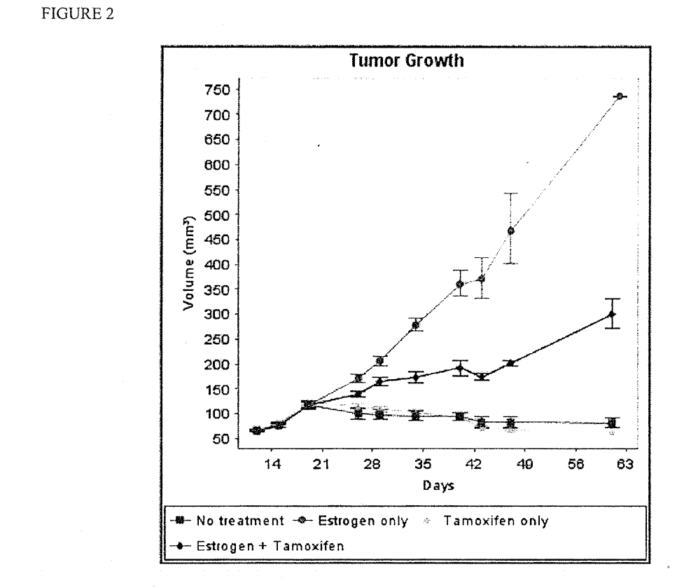

FIG. 2 shows tumor growth over time in the mouse model for breast cancer, for different (estrogen only, tamoxifen only, or estrogen+tamoxifen), or no, treatments.

Mass spectrometry was used to study the glycoproteome. As shown in FIG. 3(a), changes in the MZ pattern at 781 units, for example, can be distinguished for a mouse with a 6 week tumor. As shown in FIG. 3(b), changes in the MZ pattern at 945 units, for example, can be distinguished for a mouse with a growing tumor with estrogen only treatment versus estrogen+tamoxifen treatment (note: results for two samples are shown for each treatment). Other distinctive tumor patterns can be distinguished at different MZ values (e.g., 681, 821, and 1002 units). MZ values may range, for example, from 200-1500.

Comparisons of proteomic analyses can be displayed graphically. For example, as shown in FIG. 4, a color or grayscale intensity spectrum can report the level of similarity between bio-bars for each different MZ value (y-axis) and different sample pairs (x-axis). Here, comparisons between eight samples (numbered 1, 2, 3, . . . , 8) from the mouse breast cancer model are shown, in a two-way cluster map with Tanimoto features. Comparable samples having similar experimental conditions (e.g., sample nos. 5 and 6 are both for week 6 tumor with estrogen treatment) are similar (darker color for most m/z values; see arrow at “6,5”), while samples from different experimental conditions (e.g., sample nos. 6 and 8, for week 6 tumor with estrogen treatment versus estrogen+tamoxifen treatment) are different (do not correlate well and have lighter color for most m/z values; see arrow at “8,6”). The graphical representation of the “8,6” comparison reflects the differences seen in corresponding MZ patterns at 945 units (FIG. 3) for these conditions, which in turn reflect the differences in measured tumor sizes illustrated in FIG. 2.

### Example 2

### Human Diabetes-Related Bio-Bars

Results from a diabetes study performed using human plasma samples for MS analysis are illustrated in FIG. 5. Distinctive diabetes MZ patterns can be distinguished at different MZ values (e.g., 681, 750, and 781 units). FIG. 5(a) illustrates differences in MZ patterns at 750 units observed for normal and diabetic samples. FIG. 5(b) illustrates differences in MZ patterns at 781 units observed for normal, obese, diabetic, and diabetic-hypertensive samples.

Accordingly, the data illustrated in FIG. 3 and FIG. 5 can be converted and stored in the knowledge database in connection with information regarding its relationship to, respectively, tumors and human diabetes (presumably the tumor data would correlate to processes associated with the development and individual response to human tumors). Thus, as data is added, information relating not only to the bio-bar or MZ pattern would be added to the knowledge database, but also information relating to the subject, that is, normal, obese, diabetic, and diabetic hypertensive in connection with FIG. 5 and, for example, tumors being treated with estrogen only, or with estrogen+tamoxifen in connection with FIG. 3. With such data and information, a knowledge database can be created against which the user-submitted samples can be correlated. The results of those correlations are then presented to the user in a fashion which may resemble the “SAMPLE COMPARISONS” illustrated in the heat map or thermal display of FIG. 4, or in other displays, in order to create an easily understandable presentation and self-instruction as one moves a mouse cursor over the illustrated display. Accordingly, when the cursor is over those portions of the display where there is high correlation to a condition, the system provides on-screen the additional information and links (see, e.g., FIG. 7) to enable the user to learn more about the condition and, using that information, to make decisions; and to enable, in particular, the user to decide where a life habit change might be appropriate or whether to see a physician to discuss the results he has seen online based on the correlations presented in the feature maps or heat maps as well as the additional information being provided to enable the user to make decisions, for example, with regard to changing lifestyle and/or seeing a physician. Further, the user can go to other potential hot spots that have come from other patient associations and get a similarity or dissimilarity score.

Additions, subtractions, deletions, and other modifications of the disclosed embodiments of the invention would be apparent to those practiced in this field and are within the scope of the following claims.

What is claimed is:

1. A method for generating a wellness profile for a user, comprising the steps of:
receiving from a user for analysis at least one sample;
performing the analysis upon the sample and generating results based on the analysis;
comparing the results of the analysis to a database containing results from analyses of a plurality of samples received from individuals;
creating an individualized health profile display based at least on the results of the comparisons;
providing a network-based interface for the user to explore the created individual health profile display; and
providing information related to at least the results of the comparisons to the display.

2. The method of claim 1, wherein the sample is a biological liquid specimen.

3. The method of claim 2, wherein the sample is plasma.

4. The method of claim 2, wherein the sample is serum or urine.

5. The method of claim 1, wherein the information is genomics data.

6. The method of claim 1, wherein the information is metabolomics data.

7. The method of claim 1, wherein the step of receiving from a user for analysis at least one sample further comprises:
receiving personal information about the user.

8. The method of claim 1, wherein the analysis is mass spectrometry.

9. The method of claim 1, wherein the analysis is spectroscopy.

10. The method of claim 9, wherein the spectroscopy is at least one of nuclear magnetic resonance and infrared spectroscopy.

11. The method of claim 1, wherein the analysis is expression profiling.

12. The method of claim 1, wherein the analysis is analysis of genomic DNA.

13. The method of claim 1, further comprising the step of:
analyzing cell cultures from diseased cells with or without one or more bioactive treatments based on the results of the comparisons.

14. The method of claim 1, wherein the step of comparing the results of the analysis to a database further comprises:
creating one or more ordered lists.

15. The method of claim 1, wherein the step of comparing the results of the analysis to a database further comprises:
creating a graphical representation of similarity.

16. The method of claim 15, wherein the graphical representation is a color or grayscale intensity map.

17. The method of claim 1, wherein the step of providing information related to the correlation of user data to the display comprises:
moving, by the user, a pointing device over the display to select a portion of the display; and
providing at least one of a link and information associated with the selected portion of the display.

18. The method of claim 17, wherein the portion of the display selected by the user is associated with a condition and the at least one of a link and information associated with the selected portion of the display is associated with the condition.

19. A method for generating a wellness profile for a user, comprising the steps of:
comparing user data to a database containing results from analyses of a plurality of samples received from individuals;
creating an individualized health profile display based at least on the results of the comparisons;
providing an network-based interface for the user to explore the created individual health profile display; and
providing information related to at least the results of the comparisons to the display.

20. The method of claim 19, wherein the user data results from proteomic analysis of a biological liquid specimen.

21. The method of claim 19, wherein the user data includes personal information about the user.

22. The method of claim 19, wherein the step of comparing a user data to a database further comprises:
creating a graphical representation of similarity.

23. The method of claim 19, using a color or grayscale intensity map for indicating a level of correlation between the user data and data locations on the display.

24. The method of claim 19, wherein the step of providing information related to the correlation of user data to the display comprises:
moving, by the user, a pointing device over the display to select a portion of the display; and
providing at least one of a link and information associated with the selected portion of the display.

25. The method of claim 19, wherein the network-based interface is provided on a mass communication device.

26. A system for generating a wellness profile for a user, comprising a computer having a processor and a memory, the memory storing computer readable program code executed by the processor for performing the following process:
comparing user data to a database containing results from analyses of a plurality of samples received from individuals;
creating an individualized health profile display based at least on the results of the comparisons;
providing an network-based interface for the user to explore the created individual health profile display; and
providing information related to at least the results of the comparisons to the display.
